(19) United States
(12) Patent Application Publication
(10) Pub. No.: US 2014/0146095 A1
(43) Pub. Date: May 29, 2014

(54) DISPLAY APPARATUS AND METHOD FOR REDUCING POWER CONSUMPTION

(71) Applicant: Samsung Electronics Co., Ltd., Suwon-si (KR)

(72) Inventors: Hyun-Hee PARK, Seoul (KR); Se-Hyeok PARK, Seoul (KR); Yong-Deok KIM, Seongnam-si (KR); Jong-Man KIM, Gunpo-si (KR); Jong-Ho KIM, Seoul (KR); Byung-Seok MIN, Seoul (KR); Jeong-hoon PARK, Seoul (KR); Min-Woo LEE, Yongin-si (KR); Ji-Young LEE, Seoul (KR); Jae-Hun CHO, Yongin-si (KR)

(73) Assignee: SAMSUNG ELECTRONICS CO., LTD., Suwon-si (KR)

(21) Appl. No.: 14/090,227

(22) Filed: Nov. 26, 2013

(30) Foreign Application Priority Data
Nov. 28, 2012 (KR) 10-2012-0136512

(51) Int. Cl. G09G 3/32

(52) U.S. Cl. CPC G09G 3/3208
USPC 345/690

(57) ABSTRACT

Provided is a display apparatus and method. The display apparatus includes an image analyzer configured to generate information about an input image, an image classifier configured to classify the input image by using the information about the input image, and an image processor configured to generate a mapping function for outputting the input image by using the information about the input image and classification information regarding the input image, and to set a maximum brightness value of the input image to a maximum brightness value which is input to the mapping function.

### CROSS REFERENCE TO RELATED APPLICATION

This application claims priority from Korean Patent Application No. 10-2012-0136512 filed in the Korean Intellectual Property Office on Nov. 28, 2012, the entire disclosure of which is hereby incorporated by reference.

### BACKGROUND

1. Field

Apparatuses and methods consistent with exemplary embodiments relate to a display apparatus and method, and more particularly, to a display apparatus and method for reducing power consumption.

2. Description of the Related Art

An Organic Light Emitting Diode (OLED) is a thin-film light-emitting diode in which a light-emitting layer is formed of an organic compound. The OLED has attracted much attention as a display technology which will substitute for a Liquid Crystal Display (LCD) panel. The OLED may be classified as a Passive-Matrix Organic Light-Emitting Diode (PMOLED) and an Active-Matrix Organic Light-Emitting Diode (AMOLED), and the OLED technology has been increasingly used in a small-size display such as a smart phone display or an MP3 display.

OLED pixels directly emit light, such that they may express rich colors by using a large color gamut, and does not need a backlight, thus having an excellent black level. However, the OLED consumes more power than the LCD, and consumes much power especially in expression of white.

### SUMMARY

Exemplary embodiments address at least the above problems and/or disadvantages and other disadvantages not described above. Also, an exemplary embodiment is not required to overcome the disadvantages described above, and an exemplary embodiment may not overcome any of the problems described above.

One or more exemplary embodiments provide a display apparatus and method for reducing power consumption.

One or more exemplary embodiments also provide a display apparatus and method for reducing power consumption while preventing degradation of image quality.

According to an aspect of an exemplary embodiment, there is provided a display apparatus including an image analyzer for generating information about an input image, an image classifier for classifying the input image by using the generated information about the input image, and an image processor for generating a mapping function for outputting the input image by using the information about the input image and classification information regarding the input image, and setting a maximum brightness value of the input image to a maximum brightness value which is input to the mapping function.

According to an aspect of another exemplary embodiment, there is provided a display method including generating information about an input image, classifying the input image by using the generated information about the input image, and generating a mapping function for outputting the input image by using the information about the input image and classification information regarding the input image, and setting a maximum brightness value of the input image to a maximum brightness value which is input to the mapping function.

### BRIEF DESCRIPTION OF THE DRAWINGS

The above and/or other aspects will be more apparent from the following detailed description taken in conjunction with the accompanying drawings, in which:

FIG. 1 is a block diagram illustrating a display apparatus according to an exemplary embodiment;

FIGS. 2A, 2B, 2C, 2D and 3 are diagrams for describing how to analyze an image in an image analyzer according to an exemplary embodiment;

FIGS. 4A, 4B and 4C are diagrams for describing how to adjust a mapping function based on a brightness rate of an image in an image processor according to an exemplary embodiment;

FIG. 5 is a diagram for describing how to generate a mapping function in an image processor according to an exemplary embodiment;

FIG. 6 is a diagram for describing how to generate a mapping function by using inter-frame relation information in an image processor according to an exemplary embodiment; and

FIGS. 7 and 8 are diagrams for describing operations of a display apparatus according to an exemplary embodiment.

### DETAILED DESCRIPTION OF EXEMPLARY EMBODIMENTS

Hereinafter, exemplary embodiments will be described in detail with reference to the accompanying drawings. In addition, a detailed description of well-known functions and constructions will not be provided if they unnecessarily obscure the subject matter of the present invention.

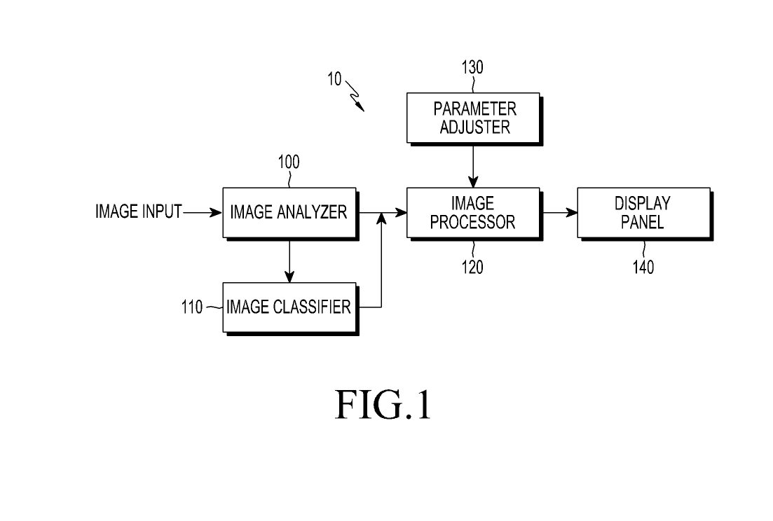

FIG. 1 is a block diagram illustrating a display apparatus 10 according to an exemplary embodiment.

Referring to FIG. 1, the display apparatus 10 may include an image analyzer 100, an image classifier 110, and an image processor 120. The display apparatus 10, may further include a parameter adjuster 130 and a display 140. The image analyzer 100, the image classifier 110, the image processor 120, and the parameter adjuster 130 may be implemented by a hardware component, such as a processor or dedicated integrated circuit, and a software component that is executed by a hardware component such as a processor. The display 140 may be an OLED display, a PMOLED display, an AMOLED display, etc., but is not limited thereto.

The image analyzer 100 analyzes an input image to generate information which may be used for reconstructing an image in an optimal form. For example, the image analyzer 100 may generate a histogram of the input image in frame units and determine a maximum brightness value, a rate of a dark region, a rate of a middle region, and a rate of a white region.

The image classifier 110 classifies the input image by using information about the histogram generated by the image analyzer 100. For example, the image analyzer 100 may determine whether the input image is a web image including a text, a web image including an image, or a web image including a moving image, based on the number of images included in the input image and a text in black and white included in the input image, and may classify the web image including many images as a moving image. This is because in a mobile device, an image having many images and an image having a text in black and white have different low-power effects and cause different reactions to a user's visual sensation, such that for a general image, power consumption needs to be reduced to maintain a contrast ratio, and for an image including a text in black and white, power consumption needs to be reduced by controlling brightness of white.

The image processor 120 generates a mapping function for outputting a low-power image to be displayed by the display 140, by using processing results of the image analyzer 100 and the image classifier 110, such as image classification information, histogram information, and maximum brightness information. The image processor 120 prevents a side effect, such as image flickering, for image output.

The parameter adjuster 130 adjusts necessary parameters to respond to various low-power output results and reflect various display characteristics in the display apparatus 10 according to an exemplary embodiment. For example, the parameter adjuster 130 may receive a value for recognizing a brightness of an image and a value for adjusting a basic strength of low power from a user, process them, and adjust a parameter value applied for image output.

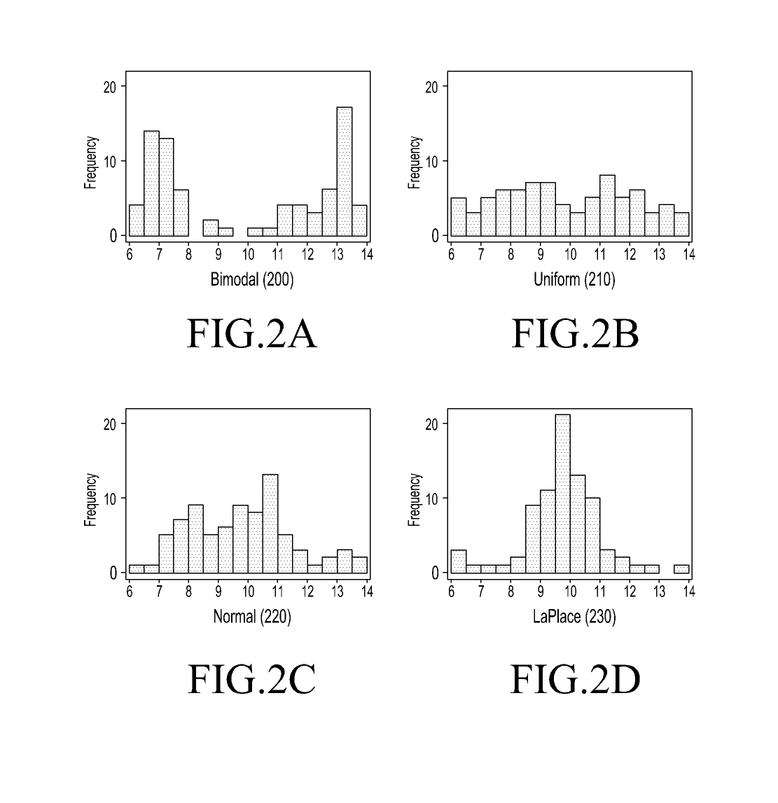

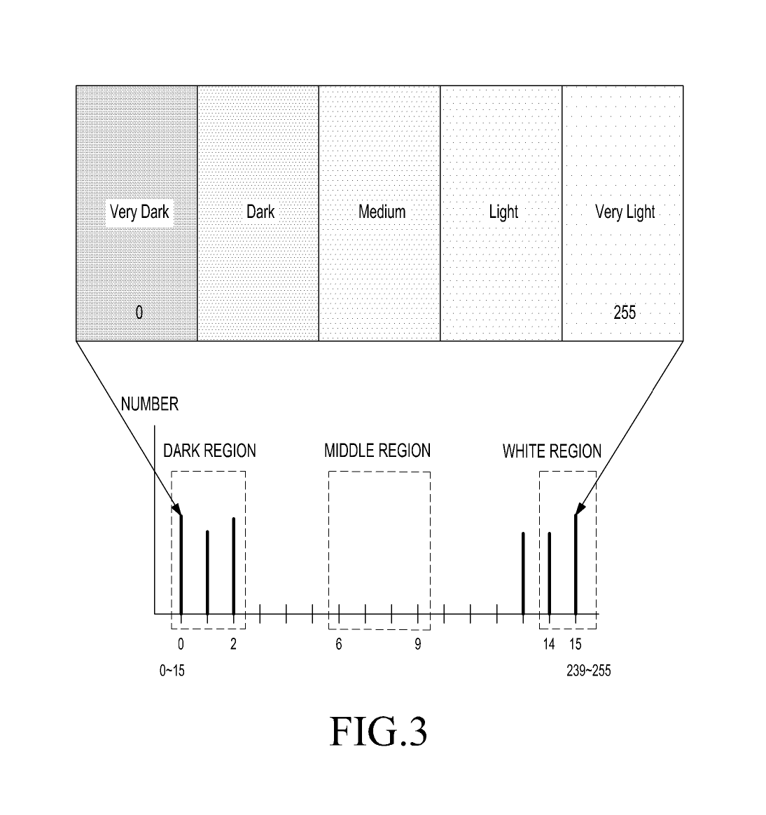

FIGS. 2A, 2B, 2C, 2D and 3 are diagrams for describing how to analyze an image in the image analyzer 100 according to an exemplary embodiment.

Referring to FIG. 2A, 2B, 2C and 2D, the image analyzer 100 according to an exemplary embodiment collects information of pixels of the input image to identify a type of a histogram of the input image. The types of histogram of the input image may be, for example, but not limited to a bimodal type histogram 200 as shown in FIG. 2A, a uniform type histogram 210 as shown in FIG. 2B, a normal type histogram 220 as shown in FIG. 2C, and a Laplace type histogram 230 as shown in FIG. 2D, and generates a histogram by sampling the collected information of pixels of the input image. The image analyzer 100 calculates a standard deviation by using a sampled histogram value per gray scale level and identifies a type of the generated histogram based on the calculated standard deviation. For example, referring to Table 1, by using a standard deviation of each histogram, a type of the histogram may be easily identified.

TABLE 1

| | Normal | Bimodal | Uniform | Laplace |
|---|---|---|---|---|
| Mean | 9.79446 | 9.92195 | 9.81643 | 9.76392 |
| Median | 9.90329 | 9.71298 | 9.69016 | 9.79031 |
| Range | 7.63654 | 7.37171 | 7.84822 | 7.51864 |
| InterQuartile Range | 2.46202 | 6.01327 | 3.50191 | 1.08383 |
| (IQR) | | | | |
| Standard Deviation | 1.73085 | 2.86692 | 2.16723 | 1.28067 |
| S/IQR | 0.70302 | 0.47677 | 0.61887 | 1.18162 |

The image classifier 110 may also classify the input image by roughly identifying the histogram as one of two types, that is, the bimodal type histogram 200 and the other types of histograms 210, 220, and 230 among the four histogram types. This is because even if the input image is identified as one of the two histogram types, a mapping function for outputting a low-power image may be generated and the low-power image may be output.

The image analyzer 100 determines a rate of a dark region of the input image, a rate of a middle region of the input image, and a rate of a white region of the input image, and the image processor 120 adjusts an intensity of the mapping function by using those rates. Referring to FIG. 3, one frame of the input image may be divided into a dark region and a white region with 0 through 255 levels. The image analyzer 100 samples 0 through 15 levels from 0 through 255 levels to avoid implementation complexity, generates a histogram, applies the generated histogram to each frame, and checks a corresponding level in each frame. Since one input image is formed of a plurality of frames, results of application to the respective frames are summed, such that a brightness distribution for one input image may be obtained.

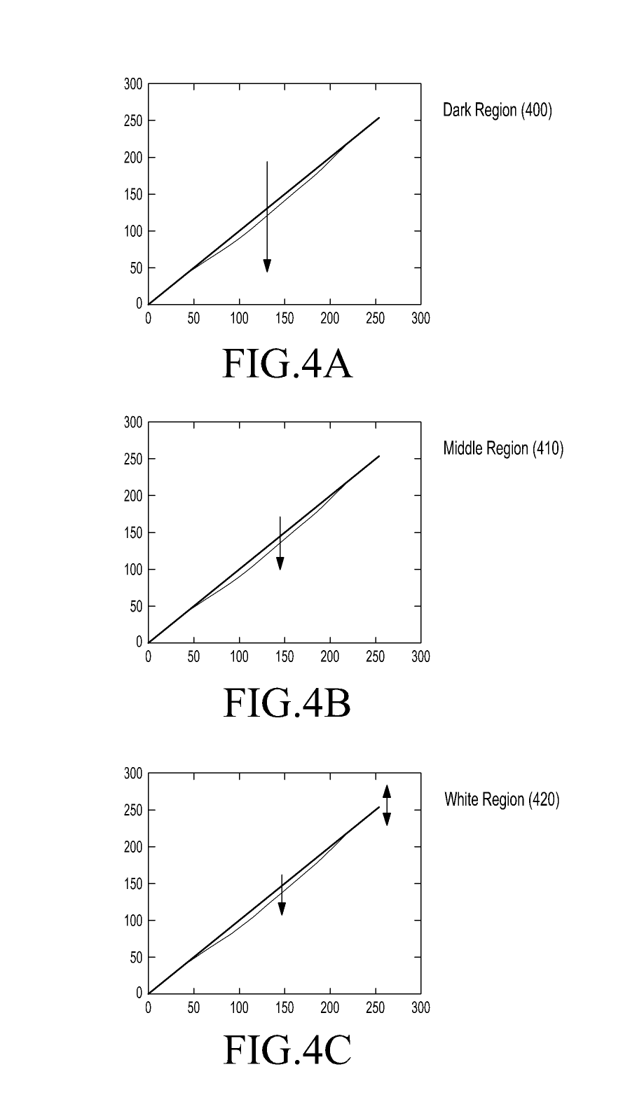

FIGS. 4A, 4B and 4C are diagrams for describing how to adjust a mapping function based on a brightness rate of an image in the image processor 120 according to an exemplary embodiment.

Referring to FIG. 4A, if the mapping function is a function regarding brightnesses of an input image and an output image and it is a case 400 where the dark region of the input image is large, the image processor 120 adjusts the mapping function such that a middle portion of the mapping function is significantly inclined downwardly. Referring to FIG. 4B, if the mapping function is a function regarding brightnesses of an input image and an output image and it is a case 410 where the middle region of the input image is large, the image processor 120 adjusts the mapping function such that the middle portion of the mapping function is inclined downwardly less than in the case 400. Referring to FIG. 4C, if the mapping function is a function regarding brightnesses of an input image and an output image and it is a case 420 where the white region of the input image is large, the image processor 120 adjusts the middle portion and an upper portion of the mapping function.

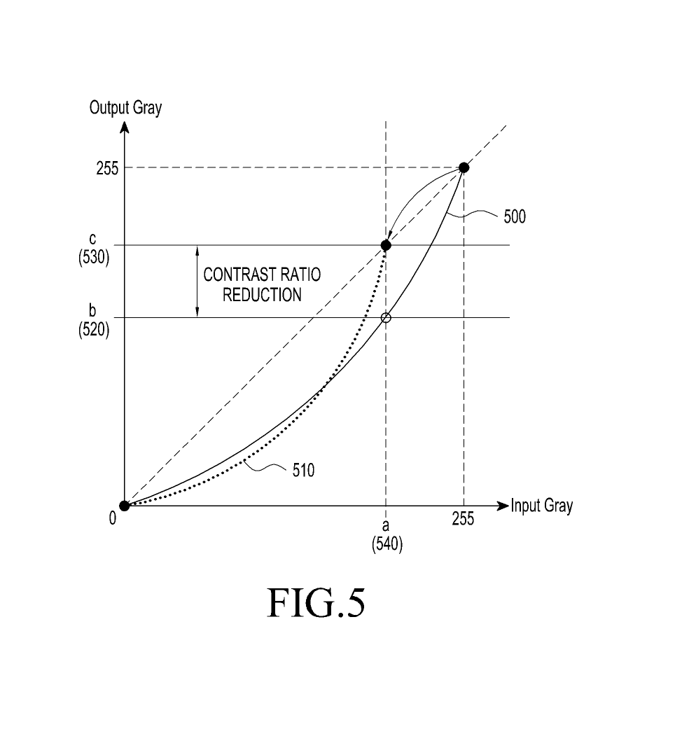

FIG. 5 is a diagram for describing how to generate a mapping function in the image processor 120 according to an exemplary embodiment.

Generally, in a histogram, the maximum brightness value of the image is set to 255, and the brightness value of the image may be indicated as levels from 0 through 255. Therefore, even when the maximum brightness value of the input image is not actually 255, the maximum brightness value of the image is set to 255, such that a contrast ratio of the output image is reduced. Such reduction in the contrast ratio may degrade the image quality. Thus, the image processor 120 according to an exemplary embodiment generates the mapping function based on the actual maximum brightness value of the input image to prevent degradation of image quality.

Referring to FIG. 5, a first mapping function 500 corresponds to a case where the maximum brightness value of the image is set to 255, and a second mapping function 510 corresponds to an exemplary case where the maximum brightness value of the image is set to an actual maximum brightness value of the input image, instead of 255. If the actual maximum brightness value of the input image is a 540 and the first mapping function 500 is used, the brightness value of the output image is b 520. If the actual maximum brightness value of the input image is a 540 and the second mapping function 510 is used, the brightness value of the output image is c 530. Therefore, by using the second mapping function 510, a contrast ratio reduction of (c-b) may be prevented.

Thus, according to an exemplary embodiment the image processor 120 generates a mapping function for outputting an output image that corresponds to the input image by using the actual maximum brightness value of the input image. The image processor 120 determines a brightness output value of the mapping function by inputting the actual maximum brightness value of the input image input to the mapping function. As a result, the image processor 120 is able to set a brightness value of the output image to be the brightness output value having been determined.

The image processor 120 generates the mapping function for the input image in frame units, and maps the input image to the generated mapping function to output the image. For example, if one input image includes 60 frames, the image processor 120 generates a mapping function for each of the 60 frames and maps each frame to the corresponding mapping function to output the image. Each mapping function may be generated using only information about the corresponding frame, and if the image is output using the mapping function generated in this way, the user may experience a side effect such as image flickering. Therefore, the image processor 120 may prevent such a side effect by generating a mapping function by using inter-frame relation information, instead of generating corresponding mapping information using information about one frame.

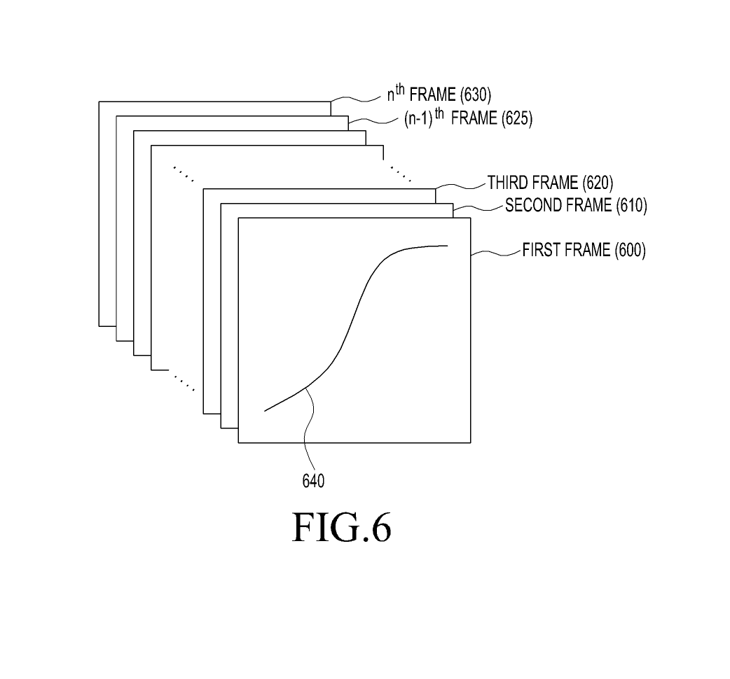

FIG. 6 is a diagram for describing how to generate a mapping function by using inter-frame relation information in the image processor 120 according to an exemplary embodiment.

The image processor 120 classifies a plurality of frames included in one input image into at least one or more groups and generates a mapping function by using average data of frames included in each group.

Referring to FIG. 6, a first frame 600 through an nth frame 630 are included in one group, and if one input image includes 60 frames, 4 groups, each of which includes 15 frames, may be formed or the total 60 frames may form one group.

The image processor 120 may use a predetermined mapping function 640 for the first frame in one group and generate a mapping function by using data regarding a preceding frame for the second frame through the last frame. That is, the image processor 120 may output an image by using the predetermined mapping function 640 for the first frame 600, and may output generate a mapping function for the second frame 610 by using data regarding the first frame 600 and the predetermined mapping function 640. The image processor 120 may generate a mapping function for a third frame 620 by using data regarding the first frame 600 and the second frame 610, and the predetermined mapping function. The image processor 120 may generate a mapping function for the nth frame 630 by using data regarding the first frame 600 through an (n-1)th frame 625 and the predetermined mapping function 640.

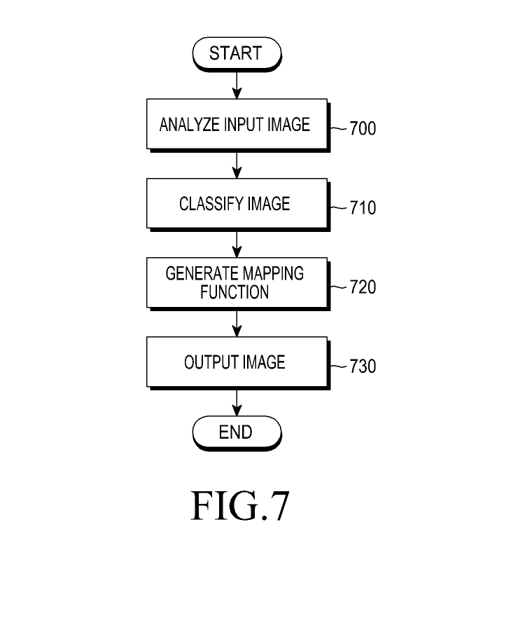

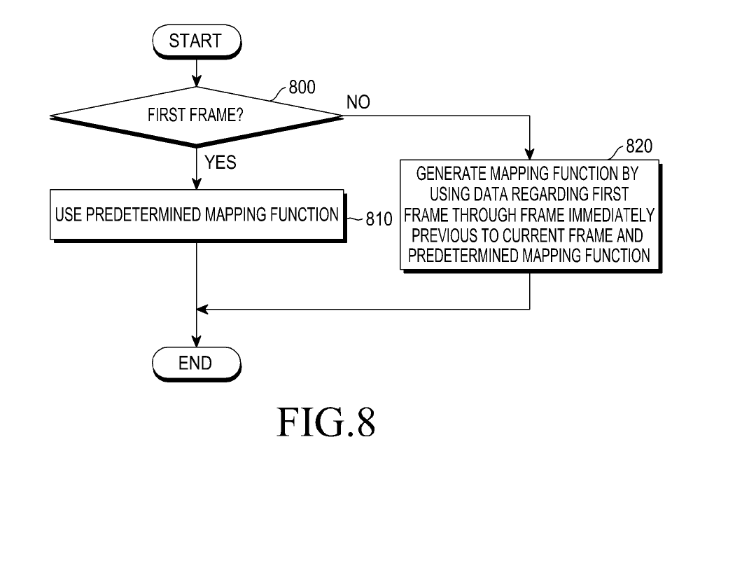

FIGS. 7 and 8 are diagrams for describing operations of the display apparatus 10 according to an exemplary embodiment.

Referring to FIG. 7, upon input of an image, the image analyzer 100 generates a histogram of the input image by analyzing the input image, and determines information about the input image, such as a maximum brightness value of the input image, a rate of a dark region of the input image, a rate of a middle region of the input image, and a rate of a white region of the input image in operation 700. In operation 710, the image classifier 110 classifies the input image as a web image, a moving image, or the like by using information about the histogram generated by the image analyzer 100. Once the image is classified, the image processor 120 generates a mapping function by using processing results of the image analyzer 100 and the image classifier 110, such as image classification information, histogram information, and maximum brightness information, in operation 720. The image processor 120 generates a mapping function for each frame of the input image, without considering inter-frame relation, by using information about each frame, or by taking account of inter-frame relation.

In FIG. 8, inter-frame relation is considered. Referring to FIG. 8, the image processor 120 divides a plurality of frames included in one input image into at least one or more groups, and uses a predetermined mapping function for the first frame of a group (YES in operation 800) in operation 810. In operation 820, for the second through last frames (NO in operation 800), the image processor 120 generates a mapping function by using data regarding the first frame through a frame which is immediately previous to the current frame in the group and the predetermined mapping function.

Once the mapping function is generated, the image processor 120 maps each frame to the corresponding mapping function and outputs the image to be displayed by the display 140 in operation 730.

As is apparent from the foregoing description, the characteristics of the input image are analyzed to classify the input image, and the mapping function suitable for the input image is generated to output the image, thereby reducing the power consumption of the display apparatus and preventing degradation of the image quality.

While exemplary embodiments have been particularly shown and described, various modifications or changes can be made without departing from the scope of the present invention.

Therefore, the scope of the inventive concept is not limited to the disclosed exemplary embodiments, and it should be defined by the scope of the following claims and equivalents thereof.

What is claimed is:

1. A display apparatus comprising:
an image analyzer configured to generate information about an input image;
an image classifier configured to classify the input image by using the information about the input image;
an image processor configured to generate a mapping function for outputting the input image by using the information about the input image and classification information regarding the input image, and to set a maximum brightness value of the input image to a maximum brightness value which is input to the mapping function.

2. The display apparatus of claim 1, wherein the information about the input image comprises at least one of information about a histogram of the input image, a maximum brightness value of the input image, a rate of a dark region of the input image, a rate of a middle region of the input image, and a rate of a white region of the input image.

3. The display apparatus of claim 1, wherein the image analyzer generates the information about the input image for each of one or more frames included in the input image.

4. The display apparatus of claim 1, wherein the image classifier classifies the input image as a web image comprising one of an image, a text, and a moving image, based on a number of images included in the input image and a text in black or white included in the input image.

5. The display apparatus of claim 1, wherein the image processor is further configured to generate the mapping function for each frame included in the input image.

6. The display apparatus of claim 5, wherein the image processor is further configured to generate the mapping function for each frame included in the input image by using information about a histogram of the frame, maximum brightness information, and classification information regarding the input image.

7. The display apparatus of claim 1, wherein the image processor is further configured to classify a plurality of frames included in the input image into at least one group, to use a predetermined mapping function for a first frame included in a group of the at least one group, and to generate a mapping function for an nth frame of the group of the at least one group by using data regarding the first frame through an (n-1)th frame of the group of the at least one group and the predetermined mapping function.

8. The display apparatus of claim 1, further comprising a display configured to display an image, wherein the image processor maps the input image to the mapping function and outputs the mapped input image to the display.

9. A method for displaying an image, the method comprising:
generating information about an input image;
classifying the input image by using the information about the input image;
generating a mapping function for outputting the input image by using the information about the input image and classification information regarding the input image;
setting a maximum brightness value of the input image to a maximum brightness value which is input to the mapping function.

10. The method of claim 9, wherein the information about the input image comprises at least one of information about a histogram of the input image, the maximum brightness value of the input image, a rate of a dark region of the input image, a rate of a middle region of the input image, and a rate of a white region of the input image.

11. The method of claim 9, wherein the generating of the information about the input image comprises generating the information about the input image for each of one or more frames included in the input image.

12. The method of claim 9, wherein the classifying the input image comprises classifying the input image as a web image comprising one of an image, a text, and a moving image, based on a number of images included in the input image and a text in black or white included in the input image.

13. The method of claim 9, wherein the generating the mapping function comprises generating the mapping function for each frame included in the input image.

14. The method of claim 13, wherein the generating the mapping function further comprises generating the mapping function for each frame included in the input image by using information about a histogram of the frame, maximum brightness information, and classification information regarding the input image.

15. The method of claim 9, wherein the generating the mapping function comprises:
classifying a plurality of frames included in the input image into at least one or more groups;
using a predetermined mapping function for a first frame included in a group of the at least one or more groups; and
generating a mapping function for an nth frame the group of the at least one or more groups by using data regarding the first frame through an (n-1)th frame of the group of the at least one or more groups and the predetermined mapping function.

16. The method of claim 9, further comprising displaying an output image corresponding to the input image.

17. An apparatus comprising:
an image analyzer configured to determine an actual maximum brightness value of an input image; and
a processor configured to generate a mapping function for outputting an output image corresponding to the input image by using the actual maximum brightness value of the input image, to determine a brightness output value by inputting the actual maximum brightness value of the input image input to the mapping function, and to set a brightness value of the output image to the brightness output value.

18. The apparatus according to claim 17, wherein the input image includes a plurality of frames, and the processor is further configured to determine whether a current frame of the plurality of frames is a first frame of the input image, if the current frame of the plurality of frames is the first frame of the input image, then the processor generates, as the mapping function, a predetermined mapping function, and if the current frame of the plurality of frames is not the first frame of the input image, then the processor generates, as the mapping function, a mapping function by using the first frame through a frame immediately previous to the current frame and the predetermined mapping function.

19. The apparatus according to claim 17, wherein the image analyzer determines information about the input image including the actual maximum brightness value of the input image by using a histogram of the input image.

20. The apparatus according to claim 19, further comprising an image classifier configured to determine classification information of the input image by using the information about the input image determined by the image analyzer, wherein the processor generates the mapping function by using the information about the input image including the actual maximum brightness value of the input image and the classification information of the input image.
